(19) United States
(12) Patent Application Publication
(10) Pub. No.: US 2005/0151084 A1
(43) Pub. Date: Jul. 14, 2005

(54) Gamma camera for emission tomography and method for adaptive event position estimation

(76) Inventors: Michael Zibulevsky, Haifa (IL); Alexander Bronstein, Haifa (IL); Michael Bronstein, Haifa (IL); Y. Yehoshua Zeevi, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/503,984

(22) PCT Filed:
(86) PCT No.: PCT/IL03/00107

Related U.S. Application Data
(60) Provisional application No. 60/356,701, filed on Feb. 14, 2002.

(51) Int. Cl. G01T 1/164

(52) U.S. Cl. 250/363.03

(57) ABSTRACT

A method is provided for estimating a line of flight of coincident photons in an emission tomography system, the system including an array of gamma radiation detectors and a line of flight estimator, the method comprising taking responses resulting from detection of a pair of photons by a pair of opposite detectors, consisting of a first detector and a second detector, in the array that are on opposite sides of the line of flight and estimating directly the line of flight by the line of flight estimator, taking into account responses from both detectors. There is further provided a gamma camera for use in an emission tomography system, the camera comprising two or more stacked layers of solid state gamma radiation detectors.

### FIELD OF THE INVENTION

The subject of the invention relates to the field of precise resolution and detection in gamma cameras used for emission tomography. More particularly it relates to gamma camera for emission tomography and method for adaptive event position estimation.

### BACKGROUND OF THE INVENTION

Detection of high-energy photons emitted as the result of radioactive decay is one of the most important low-level stages in different methods of nuclear medical imaging. In particular, photon detection is an important stage prior to image reconstruction in positron emission tomography (PET). The ability to precisely detect the coordinates of scintillation events implies low uncertainty of the data passed to the reconstruction algorithm and thus allows obtain tomographic scans of high quality.

The central part of a typical photon detector commonly used in PET scanners is the Anger scintillation camera. Incident high-energy gamma quanta produce a scintillation effect in the scintillation crystal of the detector, emitting a shower of optical photons in visible and UV spectra. These photons are collected by an array of photomultiplier tubes (PMT), optically coupled to the scintillation crystal, and invoke electric impulses in them. According to the photoelectric peaks, the scintillation point coodinates can be estimated. It is possible to replace the photomultiplier tubes by alternative photoelectric converting devices.

Different designs of scintillation cameras use crystals of different type and thickness and different configuration of PMTs. The majority of detection algorithms proposed in publications and patents are relatively general and can be used with sufficient accuracy with different detector designs.

A special case is thick crystals with high penetration distance. The application of most common algorithms for photon detection appears problematic in case of non-collimated Anger cameras utilizing thick crystals due to significant parallax observed at large incidence angles. This effect decreases the estimation accuracy of most algorithms and limits their application in fully-3D PET.

Another problem is the effective detection area of a scintillation detector. Most algorithms, especially those based on centroid arithmetic, have a limited region in which they can produce a precise estimation of the scintillation point. As the result, distant scintillation events suffer from high positional uncertainty and must be neglected. Neglecting photons is undesired in PET scans since utilizing as much emitted photons as possible allows to reduce the injected radiopharmaceutical dose and decrease patients exposure to radiation.

The first construction of scintillation gamma camera and the scintillation point estimation algorithm based on centroid arithmetic is disclosed in U.S. Pat. No. 3,011,057 by H. O. Anger, 1961. The author proposes a simple resistive electronic circuit to obtain a weighted sum of the PMT outputs, which estimates the planar coordinates of the scintillation event. This basic algorithm, as well as some of its variations, is described in depth in the Part II of this report.

One of the drawbacks of the basic estimation algorithm (named after its inventor H. O. Anger) is the fact that the light from a scintillation event can spread extensively within the crystal before it reaches the PMTs and that as a PMT is increasingly remote from an event, the quality of information from that PMT is reduced. Thus, as disclosed in U.S. Pat. No. 3,732,419 (Kulberg et al.), issued in 1973 threshold preamplifiers can be used to reject weak PMT outputs, preventing their utilization in the centroid calculations. Only if a PMT output exceeds a predetermined threshold is that output permitted to enter the resistor matrix for weighting and contributing to the centroid determination. This algorithm, referred to as Anger algorithm with threshold preamplifiers, is described in Part II.

Correction schemes for Anger-type and all-digital scintillation cameras are disclosed in several patents. A version of an algorithm based on correction matrices (termed by some authors as calibration maps or lookup tables) is disclosed in French patent No. 2530824 (Inbar), of 1984.

Position-dependent correction Anger algorithm is disclosed in European patent No. 0450388 (Malmin), of 1991. In this scheme, an approximation of the scintillation point is calculated using a coarse estimation algorithm (such as classical Anger algorithm). The weighting factors and the PMTs involved in the scintillation point estimation are identified as a function of the approximated point; the location of the scintillation point is calculated using only the outputs of the identified PMTs and the identified weighting factors. The identification stage is carried out using correction matrices. This scheme can be iterated producing better approximation at the expense of computing time.

Other iterative algorithms are disclosed in several patents. One of such approaches uses maximization of likelihood function. The use of maximum likelihood estimator based on Poisson model for statistical fluctuations of the output signals of the PMTs is proposed in U.S. Pat. No. 5,293,044 (Kligenberg-Regn et al.) of 1994. According to the proposed algorithm, an iterative refinement scheme is implemented: a rough pre localization of the scintillation point is done using a coarse grid, then a finer grid is superimposed around the point of the coarse grid with the highest value of the probability function.

An improvement is disclosed in U.S. Pat. No. 5,285,072 (Kligenberg-Regn et al.) of 1984, in which the same authors propose an algorithm to resolve multiple scintillation events using pattern recognition approach. According to the proposed scheme, PMT output signals are compared with multiple comparative signal sets. The locations of the multiple scintillation events in question are then registered as coinciding with the known origins belonging to the multiple comparative signal set which generates the greatest similarity value with the output signals in question.

Another version of maximum likelihood approach is disclosed in U.S. Pat. No. 5,444,253 (Belrad) of 1995.

The fact that the sensitivity of the PMTs is not the same and may vary with time, especially when an old PMT is replaced with a new one; that PMTs tend to be more sensitive at some angles than at others; and that some portions of the crystal interact more strongly with the gamma radiation lead to the proposal of more advanced correction and calibration schemes. One widely used methodology for correction of gamma cameras is the so-called triple correction, versions of which are described in U.S. Pat. Nos. 4,424,446 (Inbar et al.) of 1984 and 4,588,897 (Gafni et al.) of 1986. These patents describe a correction system, which corrects for dislocation distortions, energy response variations and non-uniform sensitivity of the scintillation camera. One of the most significant drawbacks of such calibration is its very extensive duration (up to 3 days), which naturally limits the calibration frequency.

An advanced scheme, which allows overcome the problem of the correction map determination is disclosed in PCT No. WO9819179 (Belrad et al.) of 1998. The authors propose to view the gamma camera distortions as comprising of characteristic part typical for a camera of a certain design; and specific part, which is typical for a particular may vary significantly from camera to camera of the given design. The triple correction scheme is carried out using a correction map or an artificial neural network, either combined with Anger algorithms for correction or bypassing it.

Application of non-linear estimation methods for photon detection has not been extensively examined in previous publications. To the best of our knowledge, the only significant publications on the attempt to use neural networks for photon detection are S. Delorme et al, “Use of a neural network to exploit light division in a triangular scintillating crystal,” Nuclear Instruments and Methods in Physics Research A 373, pp. 111-118, 1996 and D. Clement, R. Frei, J-F. Loude and C. Morel, “Development of a 3D Position Sensitive Scintillation Detector Using Neural Networks,” Proc. of the IEEE Med. Imag. Conf., Toronto, November 1998.

One of the tools used for non-linear parametric estimation is an artificial neural network (ANN). ANN-based algorithms bypass the Anger coarse estimator and produce an approximation of the scintillation point according to the PMT electrical pulses.

Training a big neural network to either correct or bypass a coarse estimator appears inefficient in most cases, especially if a large crystal is considered. Using this method, one has to “trade-off” between estimation accuracy and the training and estimation time, since large neural networks naturally have longer training on one hand, and smaller neural networks would not provide sufficiently good generalization and would not produce precise estimation, on the other.

One of the novelties of the invention that is the subject of this application, is to restrict the activity of each neural network to a small region of the crystal. A set of independent neural networks should be trained on training data from different overlapping regions, so that supposing scintillation events only in a certain region, the corresponding neural network would produce an estimation of the scintillation point with high spatial resolution. A coarse estimation algorithm (one of Anger basic algorithms or a coarse ANN based estimator) is used then to locate the scintillation region and to pick up the neural network for precise estimation.

Another aspect by which the invention that is the subject of this application differs from that proposed by the authors of PCT No. WO9819179 is the fact that we do not assume a collimated gamma camera. Non-collimated scintillation detectors, used primarily in fully-3D PET, appear to be problematic for an algorithm with a single neural network, since such method cannot appropriately treat different incidence angles. This problem is acute in thick crystals with high penetration distance (e.g. Nal), since in such detectors the parallax resulting from large incidence angles may significantly deteriorate the estimation accuracy.

The present invention assumes the incidence angle to be known. It can be estimated from the line of response using the coincident event in the opposite detector. This allows training a neural network not only for a certain region of the crystal, but also for a certain coincidence angle, improving the estimation accuracy. The advanced detection scheme therefore comprises a set of neural networks trained at different regions for different incident angles.

In addition to neural networks, other nonlinear estimation tools such as neuro fuzzy systems and support vector machines (SVM) can be applied. These systems are similar to neural networks and are used for correction of a coarse Anger estimator or replace such estimator.

### BRIEF DESCRIPTION OF THE INVENTION

In accordance with a preferred embodiment of the present invention, there is provided a method for estimating a line of flight of coincident photons in an emission tomography system, the system including an array of gamma radiation detectors and a line of flight estimator, the method comprising taking responses resulting from detection of a pair of photons by a pair of opposite detectors, consisting of a first detector and a second detector, in the array that are on opposite sides of the line of flight,
estimating directly the line of flight by the line of flight estimator, taking into account responses from both detectors.

Furthermore, in accordance with a preferred embodiment of the present invention, the estimator is model based.

Furthermore, in accordance with a preferred embodiment of the present invention, the estimator is trainable.

Furthermore, in accordance with a preferred embodiment of the present invention, the training comprises using a source of photons with a known direction.

Furthermore, in accordance with a preferred embodiment of the present invention, further comprising:
dividing a range of outputs into subsets of ranges,
training a simple estimator for each subset of ranges,
making a coarse estimation of an output to select the appropriate simple estimator,
applying the selected simple estimator to the output.

Furthermore, in accordance with a preferred embodiment of the present invention, the range of outputs is the direction of line of flight.

Furthermore, in accordance with a preferred embodiment of the present invention, the range of outputs is the coordinates of the point of incidence.

Furthermore, in accordance with a preferred embodiment of the present invention, the range of outputs is the photon energy.

Furthermore, in accordance with a preferred embodiment of the present invention, the range of outputs is any combination of the direction of line of flight, the coordinates of the point of incidence, or the photon energy.

Furthermore, in accordance with a preferred embodiment of the present invention, the estimator is a neural network trained on data from a physical system.

Furthermore, in accordance with a preferred embodiment of the present invention, the estimator is a neural network trained on simulated data.

Furthermore, in accordance with a preferred embodiment of the present invention, estimating directly the line of flight by the line of flight estimator, includes:
estimating a photon incidence point on the first detector using the responses of the second detector for coarse estimation of an incidence angle;
estimating a photon incidence point on the second detector using the responses of the first detector for coarse estimation of an incidence angle;
determining the line of flight to be the straight line between the photon incidence point on the first detector and the photon incidence point on the second detector.

Furthermore, in accordance with a preferred embodiment of the present invention, there is provided a scintillation camera for use in a positron emission tomography system, the camera comprising:
a scintillator;
a first light-guide layer behind the scintillator relative to the direction of coincidence;
a first photoelectric converter array coupled to the first light-guide layer,
a second light-guide layer in front of the scintillator relative to the direction of coincidence;
a second photoelectric converter array coupled to the second light-guide layer.

Furthermore, in accordance with a preferred embodiment of the present invention, the scintillation camera, wherein the first and second photoelectric converter arrays comprise photomultiplier tubes.

Furthermore, in accordance with a preferred embodiment of the present invention, there is provided a gamma camera for use in an emission tomography system, the camera comprising two or more stacked layers of solid state gamma radiation detectors.

### BRIEF DESCRIPTION OF THE FIGURES

The invention is described herein, by way of example only, with reference to the accompanying Figures, in which like components are designated by like reference numerals.

FIG. 1 is a data flow chart for a PET system.

FIG. 2 is a drawing of a basic scintillation camera.

FIG. 3A illustrates prior art line of flight estimation

FIG. 3B illustrates the improved line of flight estimation achieved using the adaptive event position estimator of the preferred embodiment of the present invention.

FIG. 4A is a block diagram of the prior art estimation process.

FIG. 4B is a block diagram of the estimation process using the adaptive event position estimator of the preferred embodiment of the present invention.

FIG. 5 is a block diagram of a preferred embodiment of the present invention, wherein a combination of coarse and fine estimators are used to determine the line of flight.

FIG. 6A depicts a possible training process of a trainable LOF estimator Φ.

FIG. 6B depicts the working mode of the LOF estimator Φ.

FIG. 7 is a drawing of an improved scintillation camera in accordance with an alternative embodiment of the present invention.

### DETAILED DESCRIPTION OF THE INVENTION

Positron emission tomography (PET). PET is based on socalled coincident imaging, in which, as the result of a radioactive reaction, a pair of high-energy photons in the gamma spectrum is emitted from the patient's body 40, as the result of administration of a radioactive tracer to the patient. The photons propagate along a collinear trajectory referred to as the line of flight 12 (LOF). Both photons hit gamma radiation detectors 50 (located across from one another along the LOF). This is termed an event.

In a preferred embodiment of thep present invention, the device used for gamma radiation detection is a scintillation detector. In another preferred embodiment of the present invention a solid state device is used for gamma radiation detection.

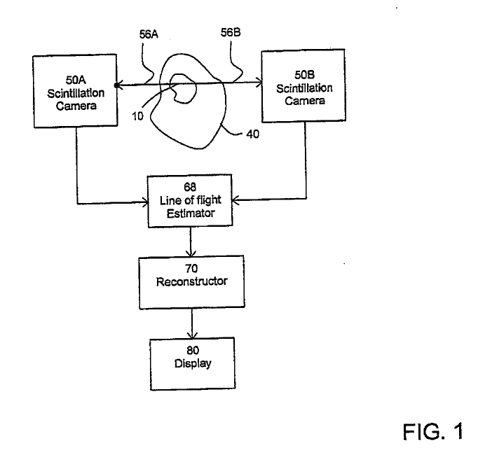

Data flow in a PET is shown in FIG. 1. Given the responses of the detectors 50A and SOB, the LOF of the photons can be estimated by the LOF estimator 68. From a set of estimated LOFs, the reconstructor 70 creates a 2D or a 3D image, which is displayed on display 80.

Detection of high-energy photons is one of the most important low-level stages in PET imaging. In scintillation detectors, a scintillation incident gamma quanta produce scintillation effect in scintillation crystal 52. As the result, a shower of low energy photons in the visible and UV spectra is emitted. These photons are collected by an array of photomultipliers (PMTs), optically coupled to the scintillation crystal, and invoke electric impulses in them. The PMT responses are utilized in estimation of the LOF.

Design of the estimator 68 is addressed in the present patent. Prior art approaches treat each detector separately, trying to estimate the coordinates of the photon interaction point (referred to as the scintillation point 62 if a scintillation camera 50 is used as a particular type of gamma radiation detector). The estimated coordinates are used to recover the LOF. One of the key ideas of the present invention is the use of information from two detectors resulting from two coincident events, as described later.

Thick crystals with high photon penetration depth, such as Nal(TI), are popular scintillation components in PET gamma cameras, due to their low cost and very high light output.

The majority of existing scintillation position estimation algorithms are based on centroid arithmetic, usually combined with correction maps. Their application appears, however to be problematic in the case of thick crystals due to significant parallax observed at large radiation incidence angles.

Tomitani et al (T. Tomitani, Y. Futami, Y. Iseki, S. Kouda, T. Nishio, T. Murakami, A. Kitagawa, M. Kanazawa, E. Urakabe, M. Shinbo and T. Kanai, “Depth Encoding of Point-of-interaction in Thick Scintillation Cameras,” Proc. of IEEE MIC, Seattle, Wash., 1999) proposed an iterative maximum likelihood algorithm for position estimation and depth encoding in thick scintillation crystals, in order to compensate for the parallax effect. However, an iterative approach necessitates extensive computations that prohibit real-time implementation.

Delorme et al and Clément et al have implemented artificial neural networks in a depth-encoding scintillation detection. The approach is flexible and offers advantages over iterative algorithms. Still, it does not resolve the problem of multiple Compton interactions, which make the conception of “depth of interaction” ambiguous.

A preferred embodiment of the current invention presents a solution for these problems, incorporating information on the photon incidence angle into the process of position estimation. It uses localized, asymptotically optimal, nonlinear estimators, implemented by feed-forward and radial basis functions (RBF) neural networks. As a byproduct, accurate position estimation over the entire area of detector including the edges is achieved.

The present invention uses a learning approach in order to build and solve the approximation of the optimal statistical model automatically, using training data, which can be available in large amounts from simulation or from physical experiment.

A crucial aspect of the present invention is that it uses the knowledge of photon direction to achieve a more accurate estimate. In this case one does not even need to estimate the 3D coordinates of each interaction. Instead, the 2D coordinate of photon entrance into the detector crystal can be estimated directly. Together with the incidence angle, this gives full description of the line of flight. By “directly” it is meant that the estimation is carried out based on information retrieved from both detectors without treating them completely separately throughout the process.

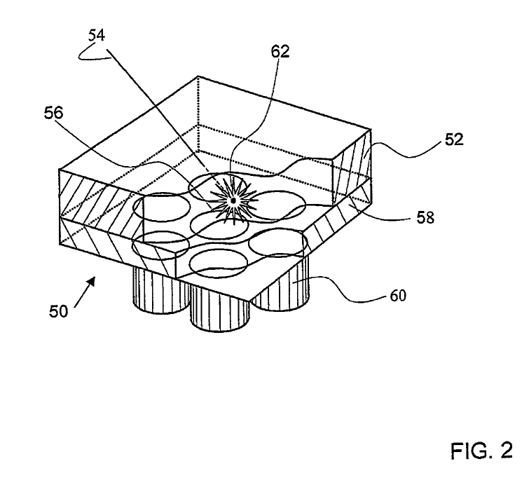

FIG. 2 illustrates a basic scintillation camera 50, comprising a scintillator 52 which emits low-energy photons 56 upon contact at scintillation point 62 by a photon 54 traveling along line of flight 12. Photons 56 pass through light guide 58 to set of PMTs 60, where they are converted to electrical signals for processing.

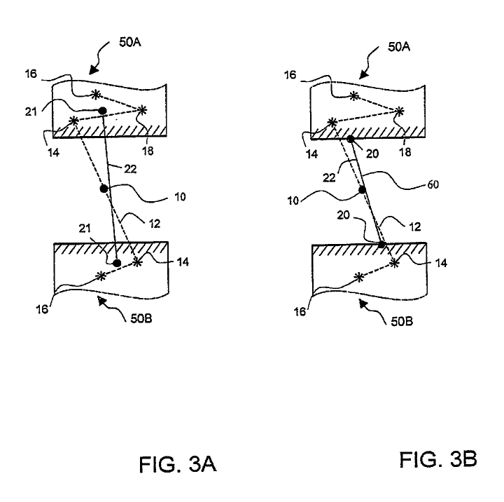

FIG. 3A illustrates prior art line of flight estimation using standard Anger algorithm. Photon pair emission source 10 emits photons 54 along actual line of flight 12. Primary interaction 14 with camera 50 is followed by secondary interaction 16 and tertiary interaction 18. Anger algorithm estimates scintillation points at 21, with resulting line of flight 22.

FIG. 3B illustrates the improved line of flight estimation achieved using the adaptive event position estimator of the preferred embodiment of the present invention. Adaptive event position estimator estimates entrance point 20, providing estimated line of flight 22, which is substantially closer to actual line of flight 12.

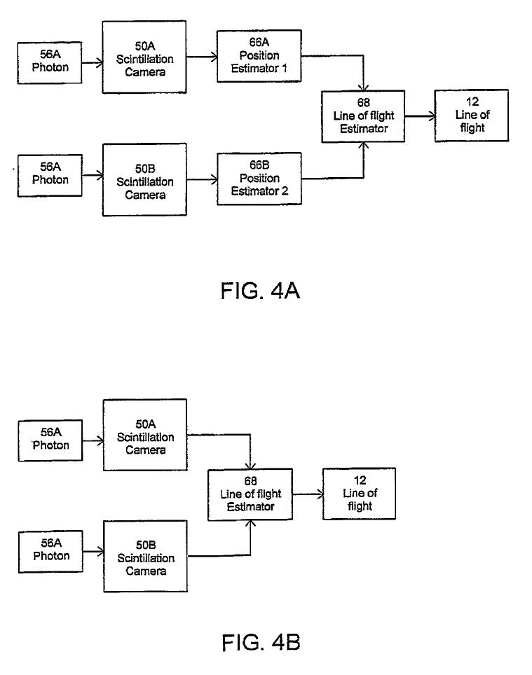

FIG. 4A is a block diagram of the prior art estimation process.

A member 56A of a photon pair is incident on scintillation camera 50A and the other member 56B on scintillation camera 50B. The coordinates of each photon's scintillation point is estimated independently, respectively in blocks 66A and 66B. The two positions are then used to determine line of flight 12 in line-of-flight estimator 68.

FIG. 4B is a block diagram of the estimation process using the adaptive event position estimator of the preferred embodiment of the present invention. Output from both scintillation cameras 50A and 50B is processed together in estimator 66 and the direct line-of-flight estimation is performed, bypassing estimation of the interaction position.

A scintillation camera 50 can be considered to be a complicated non-linear stochastic system that maps the photon line of flight (LOF) 12 into a vector x of PMT responses. Given the incidence angle, LOF is defined by planar coordinates y=(y₁, y₂) on the surface of the scintillator 52. For every incidence angle, we implement an optimal nonlinear estimator of y of the form y=Φ(x;W*), where Φ(x;W) is a family of functions, parameterized by the vector of parameters W.

A reasonable criterion for estimator optimality is the expectation of some error function E{s(Φ(x;W)−y)}, for example, the expected squared error E{∥Φ(x;W)−y∥₂²}.

We are interested in forms of Φ(x;W), that possess the property of a universal approximator: when the number of parameters W is large enough, any bounded function f(x) can be approximated with given accuracy over a bounded domain by an appropriate choice of w.

Given the PMT responses to a set of known LOFs {y^{I};x^{I}=f(y^{I})=(x₁ⁱ, . . . ,xₙ^{I})}_{iI}^{N}, (referred to as a training set), we find such W, that minimizes the mean-squared error (MSE) on the training set, i.e.:

$${W}^{*} = {arg min}_{W} {\sum }_{i = 1}^{N} {( ϕ ( {x}^{i} ; W ) - {y}^{i} )}^{2} .$$

Fine estimators, implemented as artificial neural networks, are trained on scintillation events in different (possibly overlapping) regions at a range of calibrated incidence angles. Coarse estimators, based, for example, on the Anger algorithm determine the rough position and incidence angle of the photon. According to this information, the appropriate fine estimator is selected. Such a combination of estimators allows reduction in the size of each network and accelerates the training.

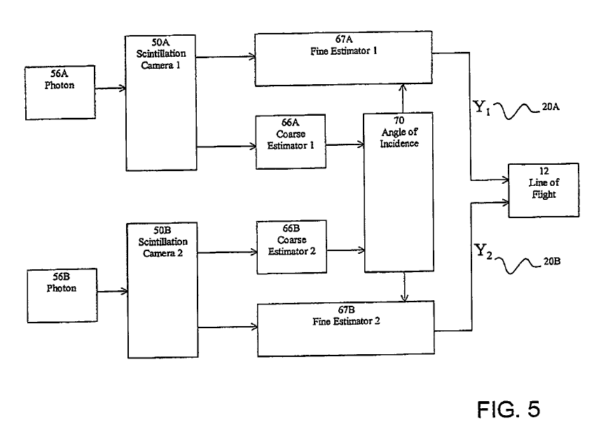

FIG. 5 is a block diagram of a preferred embodiment of the present invention, wherein a combination of coarse and fine estimators are used to determine the line of flight. Coarse estimators estimate position roughly with large error. Examples are Anger algorithm or a weighted linear sum. Fine estimators estimate position with small error and take into account the output from the opposite scintillation camera.

Photon 56A is incident on scintillation camera 50A. Output from scintillation camera 50A is processed by coarse estimator 66A and fine estimator 87A.

Photon 56B is the pair of photon 56A and is incident on scintillation camera SOB. Output from scintillation camera 50B is processed by coarse estimator 66B and fine estimator 67B. Output from coarse estimators 66A and 66B are used to estimate angle of incidence 70, which is processed by fine estimators 67A and 67B. Fine estimator 67A determines entrance point Y1 (20A) of photon 56A on scintillation camera 50A and fine estimator 67B determines entrance point Y2 (20B) of photon 56B on scintillation camera 508.

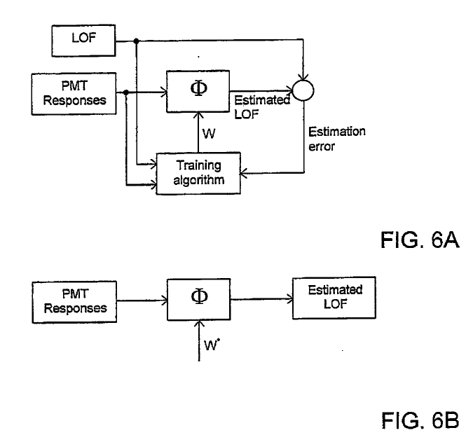

FIG. 6A depicts a possible training process of a trainable LOF estimator Φ. The estimator is fed with a set of recorded PMT responses and a LOF estimation is produced. The estimated LOF is compared to the true one from the recorded data and the produced error is fed to the training algorithm, which adjusts the estimator parameters. The process is iteratively repeated, until the optimal parameters are found.

FIG. 6B depicts the working mode of the LOF estimators Φ. Once trained, it is fed with PMT responses and outputs LOF estimates. The process can be carried out either in real time or by first storing the PMT responses invoked during the PET scan, and then processing them offline.

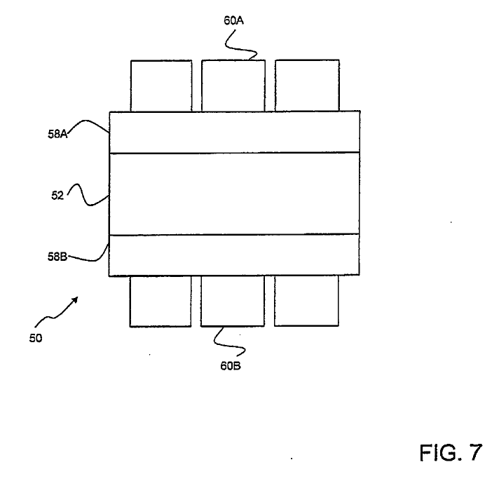

The present invention does not require a change in the hardware of the PET system. However an alternative embodiment of the present invention (FIG. 7) further improves the quality of the data from the scintillation camera 50 by adding another light guide 58A and set of PMTs 60A on top of scintillator 52 to go with the existing light guide 58B and PMTs 60B that are under scintillator 52.

Advantageously, the above described invention accomplishes the object of producing a light beam with spatially varying polarization.

It should be clear that the description of the embodiments and attached Figures set forth in this specification serves only for a better understanding of the invention, without limiting its scope as covered by the following claims.

It should also be clear that a person skilled in the art, after reading the present specification could make adjustments or amendments to the attached Figures and above described embodiments that would still be covered by the following claims.

1. A method for estimating a line of flight of coincident photons in an emission tomography system, the system including an array of gamma radiation detectors and a line of flight estimator, the method comprising
taking responses resulting from detection of a pair of photons by a pair of opposite detectors, consisting of a first detector and a second detector, in the array that are on opposite sides of the line of flight,
estimating directly the line of flight by the line of flight estimator, taking into account responses from both detectors.

2. The method of claim 1 in which the estimator is model based.

3. The method of claim 1 in which the estimator is trainable.

4. The method of claim 3 wherein the training comprises using a source of photons with a known direction.

5. The method of claim 3 further comprising:
dividing a range of outputs into subsets of ranges
training a simple estimator for each subset of ranges,
making a coarse estimation of an output to select the appropriate simple estimator,
applying the selected simple estimator to the output.

6. The method of claim 5 wherein the range of outputs is the direction of line of flight.

7. The method of claim 5 wherein the range of outputs is the coordinates of the point of incidence.

8. The method of claim 5 wherein the range of outputs is the photon energy.

9. The method of claim 5 wherein the range of outputs is any combination of the direction of line of flight, the coordinates of the point of incidence, or the photon energy.

10. The method of claim 1 where the estimator is a neural network trained on data from a physical system,.

11. The method of claim 1 where the estimator is a neural network trained on simulated data.

12. The method of claim 1, wherein estimating directly the line of flight by the line of flight estimator, includes:
estimating a photon incidence point on the first detector using the responses of the second detector for coarse estimation of an incidence angle;
estimating a photon incidence point on the second detector using the responses of the first detector for coarse estimation of an incidence angle;
determining the line of flight to be the straight line between the photon incidence point on the first detector and the photon incidence point on the second detector.

13. A scintillation camera for use in a positron emission tomography system, the camera comprising.
a scintillator;
a first light-guide layer behind the scintillator relative to the direction of coincidence;
a first photoelectric converter array coupled to the first light-guide layer;
a second light-guide layer in front of the scintillator relative to the direction of coincidence;
a second photoelectric converter array coupled to the second light-guide layer.

14. The scintillation camera as claimed in claim 13, wherein the first and second photoelectric converter arrays comprise photomultiplier tubes.

15. A gamma camera for use in an emission tomography system, the camera comprising two or more stacked layers of solid state gamma radiation detectors.

16. A scintillation camera substantially as described in the hereinabove specification and accompanying drawings.

17. A method for estimating a line of flight of coincident photons in an emission tomography system, substantially as described in the hereinabove specification and accompanying drawings.
